(19) United States
(12) Patent Application Publication
(10) Pub. No.: US 2025/0157350 A1
(43) Pub. Date: May 15, 2025

(54) SELF-HELP METHOD AND KIT USING POSITIVE AFFIRMATION

(71) Applicant: Jennifer Thomas, Naples, FL (US)

(72) Inventor: Jennifer Thomas, Naples, FL (US)

(21) Appl. No.: 18/505,755

(22) Filed: Nov. 9, 2023

(51) Int. Cl. G09B 1/02; G09F 3/02; G09F 3/04

(52) U.S. Cl. CPC G09B 1/02; G09F 3/04; G09F 2003/0208

(57) ABSTRACT

A self-help method and kit using positive affirmation includes a plurality of glass cling devices, wherein each glass cling device includes a plastic strip configured for being removably affixed to a mirror or reflective glass, a different positive affirmation imprinted on each cling device of the plurality of glass cling devices, a document including a set of printed instructions that describes a method for self-help utilizing the plurality of glass cling devices, and packaging configured for holding, transporting and displaying the plurality of glass cling devices.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to self-help and, more specifically, relates to the field of methods and products for helping consumers improve themselves with a substantial psychological basis.

### BACKGROUND

The field of self-help and self-improvement has experienced significant growth in recent years, both in its content volume and its impact on modern culture. This growth has been particularly accelerated by the ubiquity of digital technology, granting easier access to a wide range of self-help content. Platforms such as podcasts, video channels, mobile applications, and online courses have become essential tools for individuals looking to foster personal growth. Among the prevailing trends, mindfulness and meditation have emerged as popular practices, with many individuals turning to them to address challenges such as digital distractions and mental health concerns. At the same time, there's been a growing emphasis on understanding the psychology of habit formation and productivity. Books that delve into the intricacies of habits have highlighted the importance of making small yet consistent efforts to effect change. Another facet of self-improvement is the rise of biohacking, where individuals are keen to optimize various aspects of their biology, from sleep patterns to dietary habits, for enhanced performance and longevity.

However, this burgeoning industry isn't without its drawbacks. The massive commercial value of the self-help sector has led to concerns about its over-commercialization, with some experts prioritizing profit over genuine guidance. The advice given often adopts a one-size-fits-all approach, overlooking the fact that individual needs and circumstances vary widely. There's also the risk of individuals becoming too reliant on self-improvement content, leading to a situation where they spend more time absorbing advice than taking action. Another issue is the allure of quick fixes. Many resources promise rapid transformations, which can create unrealistic expectations, given that genuine change usually requires time and sustained effort. Further, while self-help can indeed be empowering, it's essential to acknowledge its limits. Lastly, too many of the self-help strategies being offered today are based on pseudoscience or blatant fake science that does not actually help consumers. In essence, while the self-help realm offers numerous benefits, it's vital to navigate it with discernment and awareness of its potential pitfalls.

Therefore, a need exists to overcome the problems with the prior art as discussed above, and particularly for a more efficient and user-friendly way of offering self-help and self-improvement methods and system to consumers.

### SUMMARY

A self-help method and kit using positive affirmation is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a self-help kit using positive affirmation is provided that solves the above-described problems. The self-help kit includes a plurality of glass cling devices, wherein each glass cling device includes a plastic strip configured for being removably affixed to a mirror or reflective glass, a different positive affirmation imprinted on each cling device of the plurality of glass cling devices, a document including a set of printed instructions that describes a method for self-help utilizing the plurality of glass cling devices, and packaging configured for holding, transporting and displaying the plurality of glass cling devices.

In another embodiment, a method for providing self-help to a consumer using positive affirmation is provided that solves the above-described problems. The self-help method includes providing a self-help kit that includes a plurality of glass cling devices, wherein each glass cling device includes a plastic strip configured for being removably affixed to a mirror or reflective glass, a different positive affirmation imprinted on each cling device of the plurality of glass cling devices, a document including a set of printed instructions that describes a method for self-help utilizing the plurality of glass cling devices, and packaging configured for holding, transporting and displaying the plurality of glass cling devices. The self-help method further includes placing at least one cling device of the plurality of glass cling devices on a mirror, and periodically standing in front of the mirror, looking at oneself in the mirror and reading the positive affirmation of the at least one cling device out loud.

### BRIEF DESCRIPTION OF THE DRAWINGS

The accompanying drawings, which are incorporated in and constitute a part of this disclosure, illustrate various example embodiments. In the drawings:

FIG. 1 depicts a vinyl cling device used in the self-help method and kit using positive affirmation, according to one embodiment.

FIG. 2 depicts the vinyl cling device used in the self-help method and kit using positive affirmation, wherein the vinyl cling device is placed on a bathroom mirror, according to one embodiment.

FIG. 3 depicts a vinyl cling device used in the self-help method and kit using positive affirmation, wherein the vinyl cling device is placed on a living room mirror, according to one embodiment.

FIG. 4 depicts a vinyl cling device used in the self-help method and kit using positive affirmation, wherein the vinyl cling device is placed on a bedroom mirror, according to one embodiment.

FIG. 5 depicts a user that has affixed the vinyl cling device used in the self-help method and kit using positive affirmation on a bathroom mirror and is reading corresponding instructions, according to one embodiment.

FIG. 6 depicts a user that has affixed the vinyl cling device used in the self-help method and kit using positive affirmation on a bathroom mirror and is repeating positive affirmations, according to one embodiment.

FIG. 7 depicts packaging holding the vinyl cling devices used in the self-help method and kit using positive affirmation, according to one embodiment.

FIG. 8 depicts an instruction card accompanying the vinyl cling device used in the self-help method and kit using positive affirmation, according to one embodiment.

FIG. 9 depicts a flowchart of the control flow of the process of the self-help method using positive affirmation, according to one embodiment.

FIG. 10 depicts a set of categories and messages for use with the glass cling devices, according to one embodiment.

### DETAILED DESCRIPTION

The following detailed description refers to the accompanying drawings. Wherever possible, the same reference numbers are used in the drawings and the following description to refer to the same or similar elements. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves over the prior art by providing a self-help method and kit that includes all of the instruments and tools necessary to improve oneself using a process that has a psychological basis, can be customized to the consumer (due to the large number of positive affirmations provided) and requires only a small amount of time each day. The claimed subject matter presents an inexpensively manufactured self-help kit that can be purchased for an economical price and easily carried and deployed for use. This feature increases the usability of the self-help kit. Further, the claimed subject matter is disposable and easily discarded so as not to burden the user. This feature facilitates usage of the self-help kit.

The claimed self-help kit serves as a potent tool rooted in psychological principles, so as to address the fundamental human need for positive self-perception and affirmation. The science of psychology has long established that affirmations, particularly when vocalized, can alter our brain's neural pathways, reinforcing positive self-beliefs and gradually negating entrenched negative thought patterns. Such practices are grounded in cognitive-behavioral theories, suggesting that positive affirmations can indeed combat self-sabotaging behaviors and thoughts, leading to enhanced mental wellness.

One of the standout benefits of the claimed embodiments is its highly customized approach to self-help. With a diverse array of positive affirmations, the self-help kit acknowledges that self-help is not a one-size-fits-all domain. Individuals resonate differently with positive affirmations based on their personal experiences, challenges, and aspirations. By offering a broad spectrum of affirmations, users are empowered to select those that strike a chord with their unique journey, thereby creating a tailored self-help experience. This customized nature ensures a deeper emotional connection, making the process more impactful.

Moreover, the claimed embodiments recognize the fast-paced lives that many individuals lead today. Traditional self-help methods might demand significant time investments-attending workshops, reading books, or practicing prolonged exercises. However, the claimed embodiments seamlessly integrate into one's daily routine without demanding additional time commitments. The mere act of looking into the mirror, a daily ritual for most, is transformed into an opportunity for self-affirmation. The brevity of this interaction, just a few moments to read and vocalize an affirmation, belies its profound impact. Over time, these fleeting moments can culminate in a significant positive shift in one's self-perception and overall mindset.

The claimed self-help kit and method ingeniously combines the science of psychology with the practicalities of everyday life. By doing so, it offers a flexible, tailored, and time-efficient tool that stands to make a considerable difference in the realm of personal development and mental well-being.

The claimed embodiments disclose a unique self-help kit and method designed to encourage positive thinking and personal affirmation. The claimed kit is distinctively crafted, consisting primarily of a series of glass cling devices, specifically tailored for mirrors or other reflective glass surfaces. Each of these glass cling devices is essentially a plastic strip, designed with the inherent flexibility to be removably affixed to such surfaces, allowing the user the freedom of positioning them as they see fit, or even relocating them to different mirrors, windows or reflective glass surfaces as needed.

Uniquely, every glass cling device in the claimed kit bears a different positive affirmation. These affirmations serve as regular reminders and encouragements, promoting a positive mindset for individuals. They have been thoughtfully chosen to cater to a wide range of self-affirming needs and are expected to resonate with a broad spectrum of consumers.

Every glass cling device has been designed with practical dimensions, with one embodiment specifically measuring approximately 2 inches by 11 inches and, for example, between 6.0 and 8.0 mils thick. This size makes the glass cling device conspicuous enough to be noticed and read but not so large as to be obtrusive. Additionally, the consumer's experience is further enhanced by the presence of a removable paper backing on each cling device. This backing, which may be white paper board, not only preserves the cling's adhesive properties but also ensures that the cling remains clean and free of dust or contaminants until it's ready to be used.

Material selection for the claimed glass cling devices includes any materials that allow for printing of text, as well as being removably attached to a glass device. The claimed glass cling devices may be made of polyvinyl chloride (PVC), a material known for its durability and flexibility, ensuring that each cling can be affixed, removed, and repositioned without losing its adhesive properties or suffering damage. Furthermore, the clear nature of the PVC allows the printed affirmations to stand out, ensuring maximum visibility without obscuring the reflective properties of the mirror. The printing process for the positive affirmations employs two potential types of inks: a solvent-based ink and an aqueous latex ink. Both inks are chosen for their long-lasting properties, ensuring that the affirmations remain vivid and legible over time.

Accompanying the claimed glass cling devices is a document, which may be composed of paper, containing a comprehensive set of instructions. This document serves as a guide, detailing the methods for effectively utilizing the clings to achieve self-help goals. In some embodiments, the instructions are printed on a paper document that is strategically placed in the packaging, as users unveil each affirmation. There's also an option to include a second document with an additional set of instructions, offering further guidance or alternative methods for use.

Packaging for the self-help kit is both functional and appealing. Designed primarily as a clear plastic bag, it allows potential purchasers to view the contained items easily. This transparent design is particularly beneficial for displaying the clings, allowing customers to preview some of the affirmations and gauge their resonance.

Utilizing the self-help kit is intuitive. Users are instructed to place one or more of the glass cling devices on their mirror or reflective glass. By periodically standing in front of this mirror, users can engage in the practice of looking at themselves and reading the positive affirmations out loud, thereby reinforcing positive self-perceptions and boosting self-esteem.

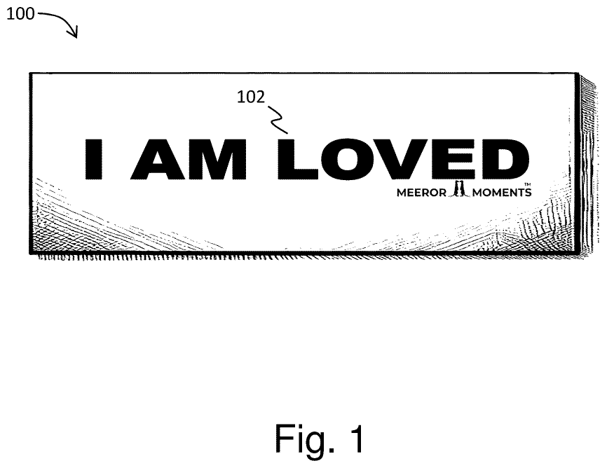

The accompanying drawings, which are incorporated in and constitute a part of this disclosure, illustrate various example embodiments. The claimed self-help method and kit will now be described with respect to FIGS. 1 through 11.

FIG. 1 depicts a vinyl cling device 100 used in the self-help method and kit using positive affirmation, according to one embodiment. FIG. 1 shows that the vinyl cling device 100 includes a printed positive affirmation, “I AM LOVED,” that may be printed in black or another colored ink and that may be a solvent-based ink or an aqueous latex ink. A logo may also be included on the bottom right hand corner of the vinyl cling device.

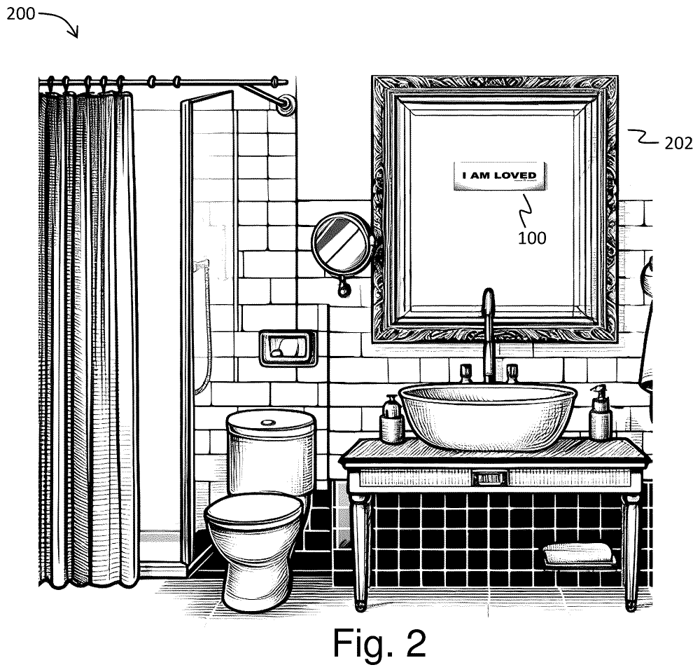

FIG. 2 depicts the vinyl cling device 100 used in the self-help method and kit using positive affirmation, wherein the vinyl cling device 100 is placed on a bathroom mirror 202, according to one embodiment. FIG. 2 shows that the claimed embodiments may be used in a variety of different rooms in the home, but that the bathroom 200 is uniquely suited to the claimed embodiments since individuals often look at themselves in the bathroom mirror 202 on a daily basis.

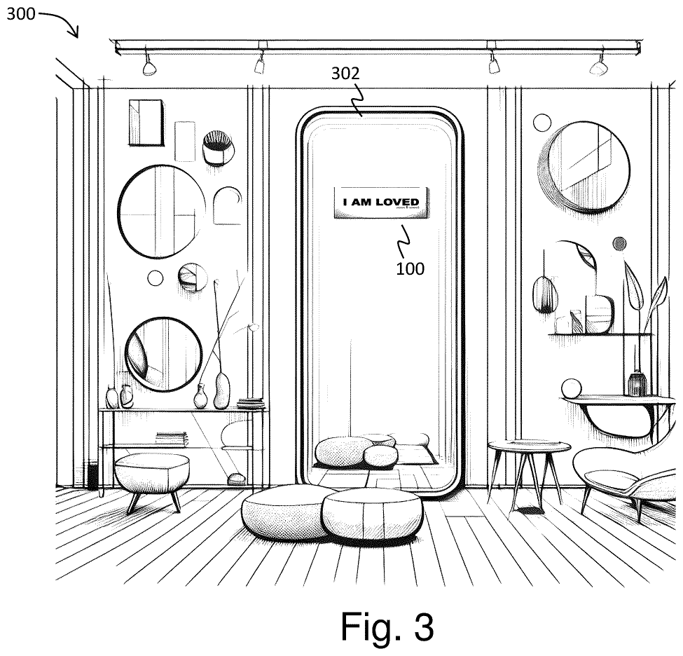

FIG. 3 depicts a vinyl cling device 100 used in the self-help method and kit using positive affirmation, wherein the vinyl cling device 100 is placed on a living room mirror 302, according to one embodiment. FIG. 3 shows that the claimed embodiments may also be used on a living room mirror 302 since people often look at themselves in a living room mirror 302 frequently as they pass through the living room 300.

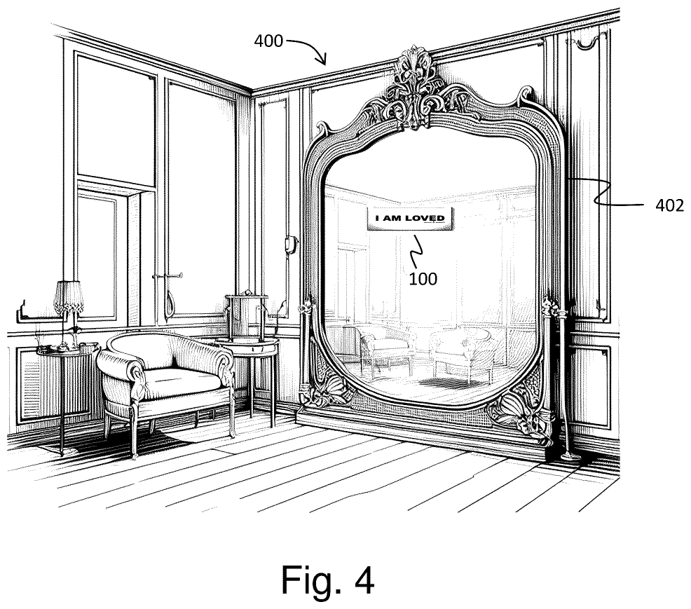

FIG. 4 depicts a vinyl cling device 100 used in the self-help method and kit using positive affirmation, wherein the vinyl cling device 100 is placed on a bedroom mirror 402, according to one embodiment. FIG. 4 shows that the claimed embodiments may further be used on a bedroom mirror 402 since people often look at themselves in a bedroom mirror 402 as the bedroom 400 is used for sleeping on a daily basis.

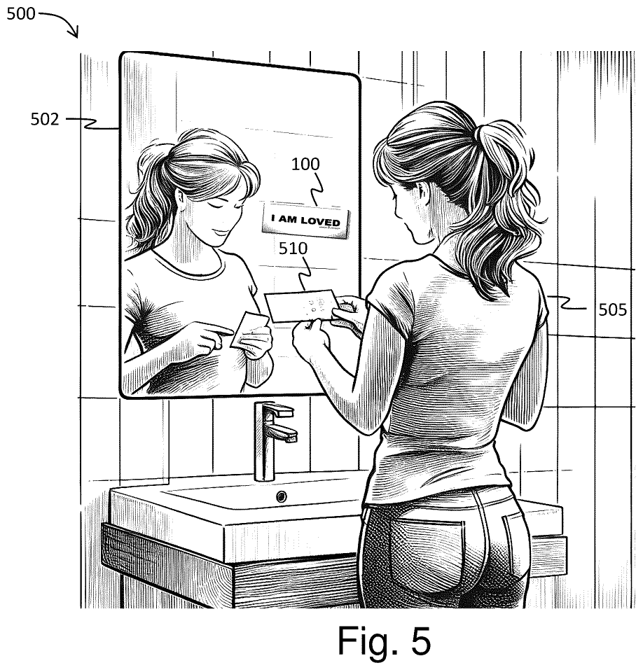

FIG. 5 depicts a user 505 that has affixed the vinyl cling device 100 used in the self-help method and kit using positive affirmation on a bathroom mirror 502 and is reading corresponding instructions 510, according to one embodiment. FIG. 5 shows that the claimed embodiments are used on a bathroom mirror 502 in the bathroom 500.

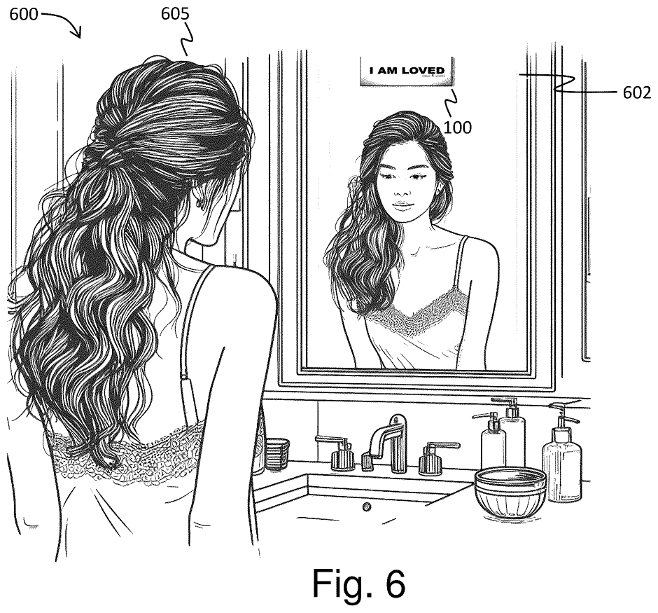

FIG. 6 depicts a user 605 that has affixed the vinyl cling device 100 used in the self-help method and kit using positive affirmation on a bathroom mirror 602 and is repeating positive affirmations, according to one embodiment. FIG. 6 also shows that the claimed embodiments are used on a bathroom mirror 602 in the bathroom 600.

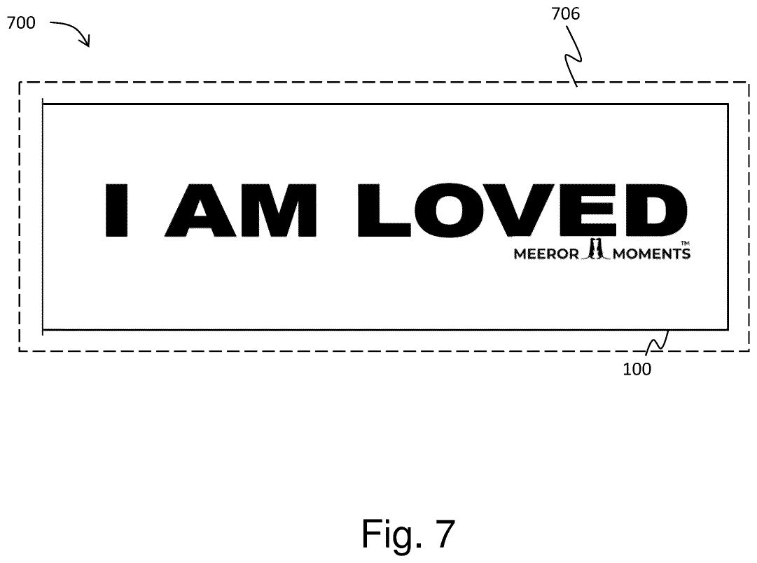

FIG. 7 depicts packaging of the vinyl cling devices 100 used in the self-help method and kit using positive affirmation, according to one embodiment. FIG. 7 shows that the packaging can include a clear plastic bag 706, in which is located the one or more glass cling devices 100, which may comprise four glass cling devices. The clear plastic bag 706 may be folded over and taped shut/sealed with a descriptive barcode sticker. Inside the packaging, there may be a document 712 (shown in the next figure) including a set of printed instructions that describes a method for self-help utilizing the glass cling devices. The document 712 may comprise a paper document. Inside the packaging, there may be a second document also including a set of printed instructions that describes a method for self-help utilizing the glass cling devices. Document 712 may include instructions, ad copy, marketing material and other information printed on one or both sides. The totality of elements shown in FIG. 7 or described with reference to FIG. 7 comprise the claimed self-help kit 700.

In one embodiment, each instance of the claimed self-help kit 700 would contain glass cling devices in a particular category, such as relationship related motivational messages, recovery related motivational messages, self-esteem related motivational messages, etc. Part of the claimed method includes having the user choose the category of glass cling devices that that resonates with the user.

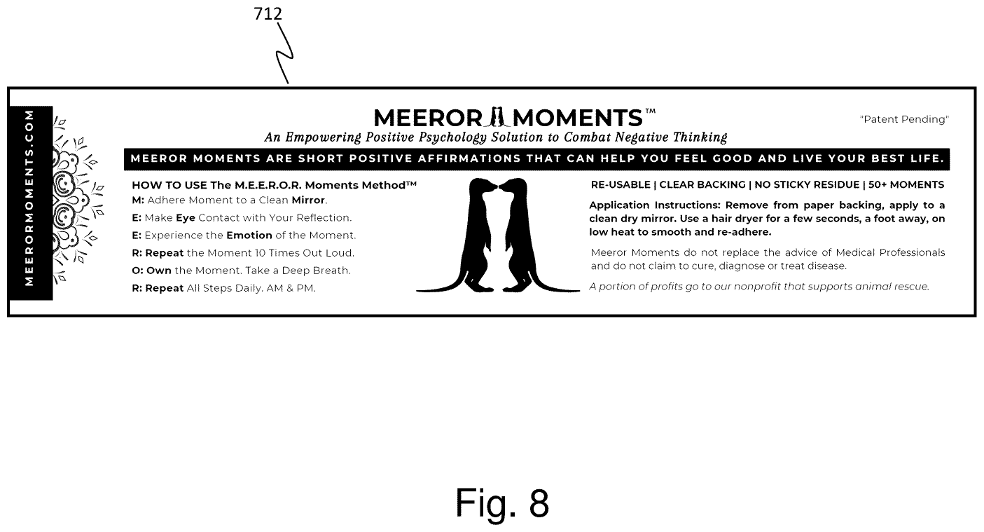

FIG. 8 depicts an instruction card 712 accompanying the vinyl cling device 100 used in the self-help method and kit using positive affirmation, according to one embodiment. FIG. 8 depicts a close up of the document 712 shown in FIG. 7 that includes a set of printed instructions that describes a method for self-help utilizing the glass cling devices 100.

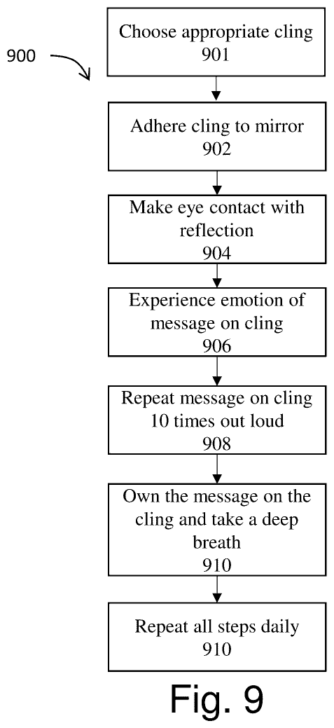

FIG. 9 depicts a flowchart of the control flow of the process 900 of the self-help method using positive affirmation, according to one embodiment. The process 900 begins with a step 901 wherein the self-help kit 700 is provided to or by the user or consumer and the consumer chooses the appropriate glass cling device from the plurality of glass cling devices in the packaging.

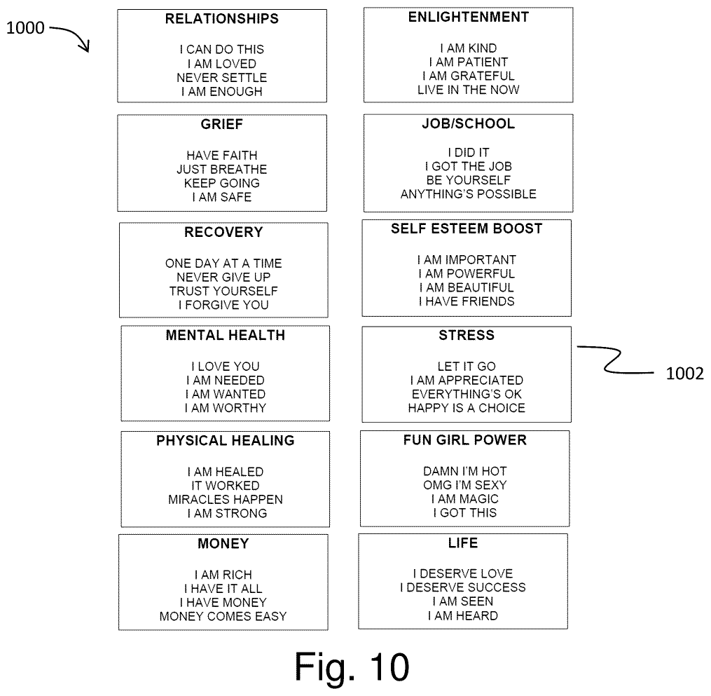

In one embodiment, each package may belong to a category wherein each category includes a set of glass cling devices with a message that pertains to that category. For example, in the relationship category, each glass cling device includes a message that pertains to relationship. The user may have a moment of self-reflection when choosing the category and message he or she feels will help. This self-awareness is also instrumental in the self-help/self-improvement experience. FIG. 10 shows a set of categories 1000 wherein each category includes a set of glass cling devices with messages that pertain to that category. For example, in the stress category 1002, each glass cling device includes a message that pertains to stress.

In step 902 the user and adheres said selected glass cling device 100 to one or more mirrors, windows or reflective glass in his or her home or other residence. In step 904, the user or consumer reads the instructions located on document 712, the user stands in front of the mirror, window or reflective glass on which the glass cling device 100 is applied, and looks at himself or herself, thereby making eye contact. In step 906, the user experiences the emotion of the message on the glass cling device. In step 908, the consumer then speaks out loud the positive affirmation written on the glass cling device one or more times (or, specifically, ten times) while looking at himself or herself, with a focus on feeling the emotion of the inspirational message of the glass cling device. In step 910, the user is encouraged to own the inspirational message of the glass cling device and take a deep breath. In step 910 the user repeats all steps daily. The user may repeat the steps each period of time passes, such as 8 hours, 12 hours or one day. The period of time may vary and may include a shortened or lengthened period of time as the consumer proceeds through the process of self-improvement. In one embodiment, the user is encouraged to engage in the steps twice a day, once in the morning and once in the evening.

Embodiments may be described above with reference to functions or acts, which comprise methods. The functions/acts noted above may occur out of the order as shown or described. For example, two functions/acts shown or described in succession may in fact be executed substantially concurrently or the functions/acts may sometimes be executed in the reverse order, depending upon the functionality/acts involved. While certain embodiments have been described, other embodiments may exist. Further, the disclosed methods' functions/acts may be modified in any manner, including by reordering functions/acts and/or inserting or deleting functions/acts, without departing from the spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A self-help kit, comprising:
a) a plurality of glass cling devices, wherein each glass cling device includes a plastic strip configured for being removably affixed to a mirror or reflective glass;
b) a different positive affirmation imprinted on each cling device of the plurality of glass cling devices;
c) a document including a set of printed instructions that describes a method for self-help utilizing the plurality of glass cling devices; and
d) packaging configured for holding, transporting and displaying the plurality of glass cling devices.

2. The self-help kit of claim 1, wherein each cling device of the plurality of glass cling devices measures about 2 inches by about 11 inches.

3. The self-help kit of claim 2, wherein each cling device of the plurality of glass cling devices is 6.0-8.0 mils thick.

4. The self-help kit of claim 3, wherein each cling device of the plurality of glass cling devices is composed of polyvinyl chloride.

5. The self-help kit of claim 4, wherein each cling device of the plurality of glass cling devices is clear.

6. The self-help kit of claim 5, wherein each positive affirmation is imprinted onto each cling device of the plurality of glass cling devices using a solvent-based ink.

7. The self-help kit of claim 5, wherein each positive affirmation is imprinted onto each cling device of the plurality of glass cling devices using an aqueous latex ink.

8. The self-help kit of claim 5, wherein the document including a set of printed instructions that describes the method for self-help utilizing the plurality of glass cling devices comprises a paper document.

9. The self-help kit of claim 8, wherein the plurality of glass cling devices comprises four glass cling devices.

10. The self-help kit of claim 9, wherein the packaging comprises a clear plastic bag.

11. A method for providing self-help to a consumer using positive affirmation, comprising:
1. providing a self-help kit, comprising:
a) a plurality of glass cling devices, wherein each glass cling device includes a plastic strip configured for being removably affixed to a mirror or reflective glass;
b) a different positive affirmation imprinted on each cling device of the plurality of glass cling devices;
c) a document including a set of printed instructions that describes a method for self-help utilizing the plurality of glass cling devices; and
d) packaging configured for holding, transporting and displaying the plurality of glass cling devices;
2. placing at least one cling device of the plurality of glass cling devices on a mirror or reflective glass; and
3. periodically standing in front of the mirror or reflective glass, looking at oneself in the mirror or reflective glass and reading the positive affirmation of the at least one cling device out loud.

12. The method of claim 11, wherein each cling device of the plurality of glass cling devices measures about 2 inches by about 11 inches.

13. The method of claim 12, wherein each cling device of the plurality of glass cling includes a removable paper backing.

14. The method of claim 13, wherein each cling device of the plurality of glass cling is composed of polyvinyl chloride.

15. The method of claim 14, wherein each cling device of the plurality of glass cling is clear.

16. The method of claim 15, wherein each positive affirmation is imprinted onto each cling device of the plurality of glass cling devices using a solvent-based ink.

17. The method of claim 15, wherein each positive affirmation is imprinted onto each cling device of the plurality of glass cling devices using an aqueous latex ink.

18. The method of claim 15, wherein the document including a set of printed instructions that describes the method for self-help utilizing the plurality of glass cling devices comprises a paper document.

19. The method of claim 18, wherein the plurality of glass cling devices comprises four glass cling devices.

20. The method of claim 19, wherein the packaging comprises a clear plastic bag and a hook coupled to the bag for hanging the packaging for display at a point of sale.
